(19) United States
(12) Patent Application Publication
(10) Pub. No.: US 2010/0110708 A1
(43) Pub. Date: May 6, 2010

(54) Rack mounted warning light

(76) Inventors: Jon H. Lyons, Haddam, CT (US); William J. Pokorny, Haddam, CT (US)

Correspondence Address: ALIX YALE & RISTAS LLP, 750 MAIN STREET, SUITE 1400, HARTFORD, CT, 06103, US

(21) Appl. No.: 12/291,227

(22) Filed: Nov. 6, 2008

(51) Int. Cl. B60Q 1/26

(52) U.S. Cl. 362/493; 362/548; 362/543

(57) ABSTRACT

A warning light adapted for mounting to an overhead rack of a vehicle has a housing which through one end forms a throat configured to receive an end of a tubular rack member. The housing includes a pair of shell members which cooperate to define the throat and openings for the first, second and third light units. The throat has a geometry which is generally complementary to the geometry of the profile of the tubular member. The shell members are configured to capture the light units for proper positioning. An upper portion of the housing allows access to an upper track of the tubular rack member. The light units are arranged to produce an illumination pattern visible from the front, side and rear of the vehicle. Preferably the first, second and third light units are substantially identical units which employ LEDs.

### BACKGROUND

This application relates generally to warning lights which are mounted to vehicles. This application also relates to racks which are mounted to vehicles such as pick-up trucks, vans and utility trucks for supporting items generally above the vehicle cab and/or bed for transport.

Racks of numerous configurations and usages have been employed on vehicles. For example, racks which extend above a truck bed or a van may employ crossbars for securing and supporting ladders above the roof of the vehicle. In some embodiments, the crossbars are elongated tubular members which are tapered for aerodynamic purposes and include an upwardly opening channel which functions as a track. Various hook and securement elements may be attached in the track for securing the cargo to be transported. Typically, the anchoring hardware is slidably adjustable along the track to accommodate numerous cargo configurations.

For some vehicular rack usages transport safety is a significant concern. It may be desirable to employ warning lights to address safety issues presented by the rack or the operation of the vehicle in general.

### SUMMARY

Briefly stated, the warning light is adapted for mounting to an overhead rack of a vehicle. The warning light has a housing which through one end forms a throat configured to receive an end of a tubular rack member. The top has a recess to provide access to an upper track of the tubular rack member. A first light unit is mounted to the housing and positioned to emit light from an end opposite the end which receives the tubular rack member. The first light unit defines a central illumination axis generally coaxial with the rack member. A second light unit defines a second central illumination axis and is mounted to the housing and positioned to emit light from an acute angle to the illumination axis and oriented generally transversely to the first light assembly. A third light unit defines a third illumination axis and is mounted to the housing and positioned to emit light from the opposite acute angle to illumination axis. Preferably the first, second and third light units are substantially identical units which employ LEDs.

The housing comprises a pair of shell members which cooperate to define the rack member opening and windows for the first, second and third light units. The shell members have integral mounting brackets configured to fixably capture the light units for proper positioning.

A tubular rack member of a vehicle has opposed longitudinally spaced ends and defines a longitudinal track at an upward portion thereof. A warning light module is mounted to the tubular rack member at one end. The module comprises a housing which receives a portion of the rack member and has a recess at a top portion to provide access to a portion of the track. A pair of transversely spaced side light assemblies is mounted to the housing and positioned to emit light in generally opposing angled directions. The third end light assembly is mounted to the housing and positioned to emit light in a generally longitudinally outward direction from the member. The housing forms a receiving throat at one end portion. The throat has a geometry which is generally complementary to the geometry of the profile of the tubular member. In one embodiment, a module is mounted at each end of the overhead rack member.

### BRIEF DESCRIPTION OF THE DRAWINGS

FIG. 1 is a top plan view of a warning light mounted to a vehicle rack (partially illustrated) with load retaining hardware;

FIG. 2 is an end elevational view of the warning light and hardware of FIG. 1;

FIG. 3 is a sectional view of the warning light and rack portion taken along the lines 3-3 of FIG. 2;

FIG. 4 is a side elevational view of the warning light, rack portion and hardware of FIG. 1;

FIG. 5 is an end view of the warning light and rack portion of FIG. 1 with the rack portion being viewed through the end thereof;

FIG. 6 is a bottom plan view of the warning light and rack portion of FIG. 1;

FIG. 7 is an exploded perspective view of the warning light, rack portion and hardware of FIG. 1;

FIG. 8 is a perspective view of the warning light and rack portion of FIG. 1 with a top cover portion being removed;

FIG. 9 is a perspective view of the warning light of FIG. 8 with the rack portion being additionally removed;

FIG. 10 is a perspective view of the warning light of FIG. 9 with a light unit being additionally removed;

FIG. 11 is a perspective view of the removed top cover portion for the warning light of FIG. 8; and

FIG. 12 is a perspective view, partly broken away and partly in schematic, of a rack with the mounted warning lights.

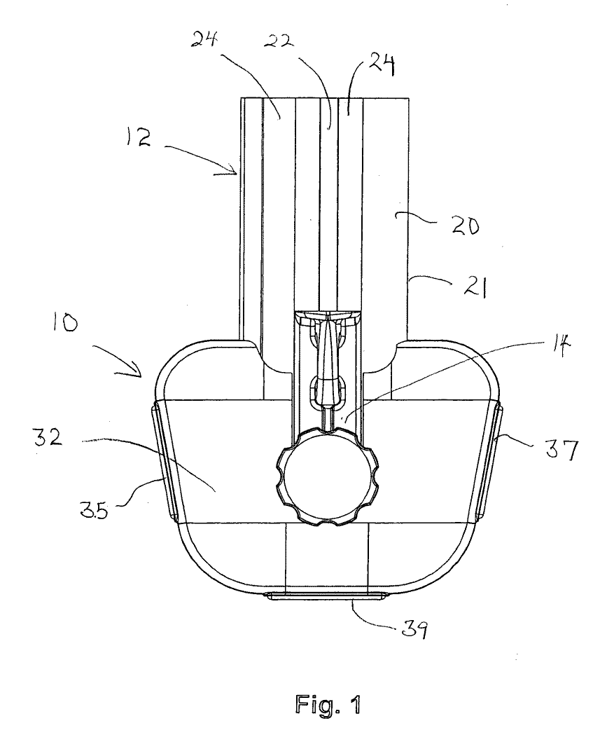

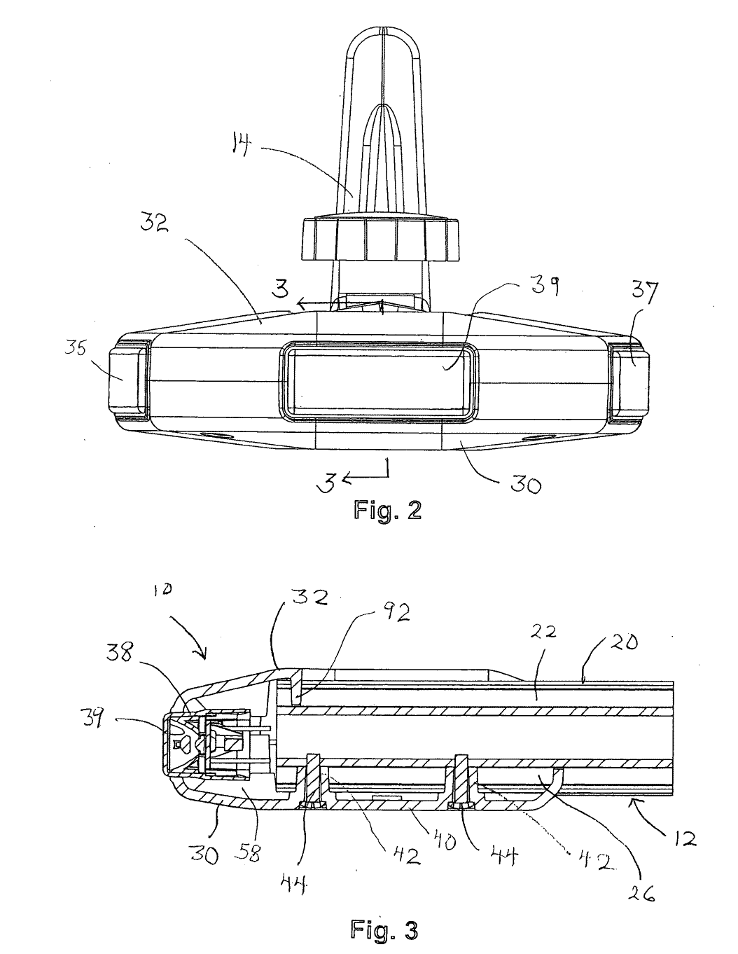

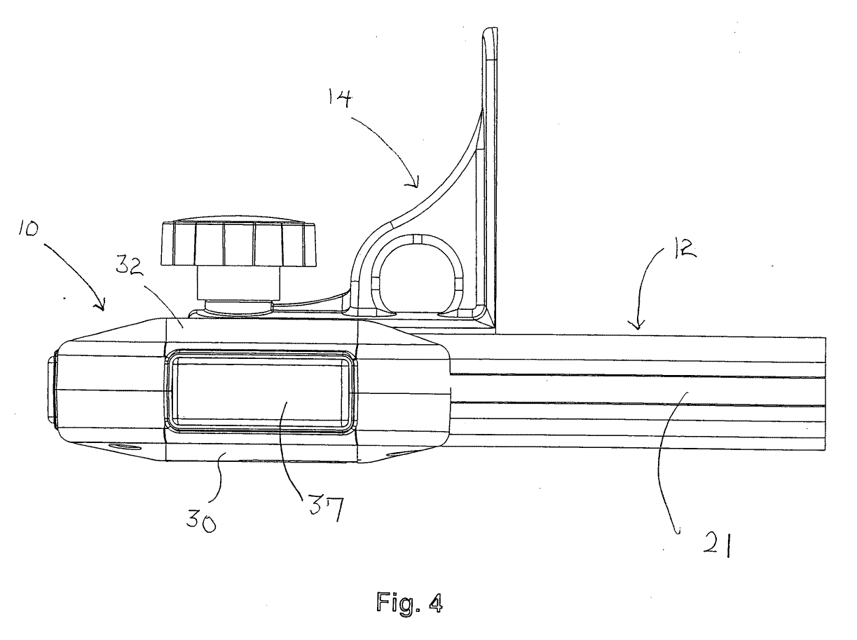

### DETAILED DESCRIPTION OF THE PREFERRED EMBODIMENTS

With reference to the drawings, wherein like numerals represent like parts throughout the Figures, a warning light designated generally by the numeral 10 is mounted to the end of a cross-support of an overhead vehicle rack designated generally by the numeral 12 and only a portion of which is illustrated. The rack may be a ladder rack for mounting to a pick-up truck, a utility van or other vehicle to facilitate the transport of ladders and other elongated materials. Variably positonable anchoring/retaining hardware 14 of conventional form and function is typically mounted to the rack. The warning light 10 is adapted to mount to the tubular cross-support of the rack assembly at each of opposing end locations to provide a safety warning light and/or to alert others to the nature of the transported materials.

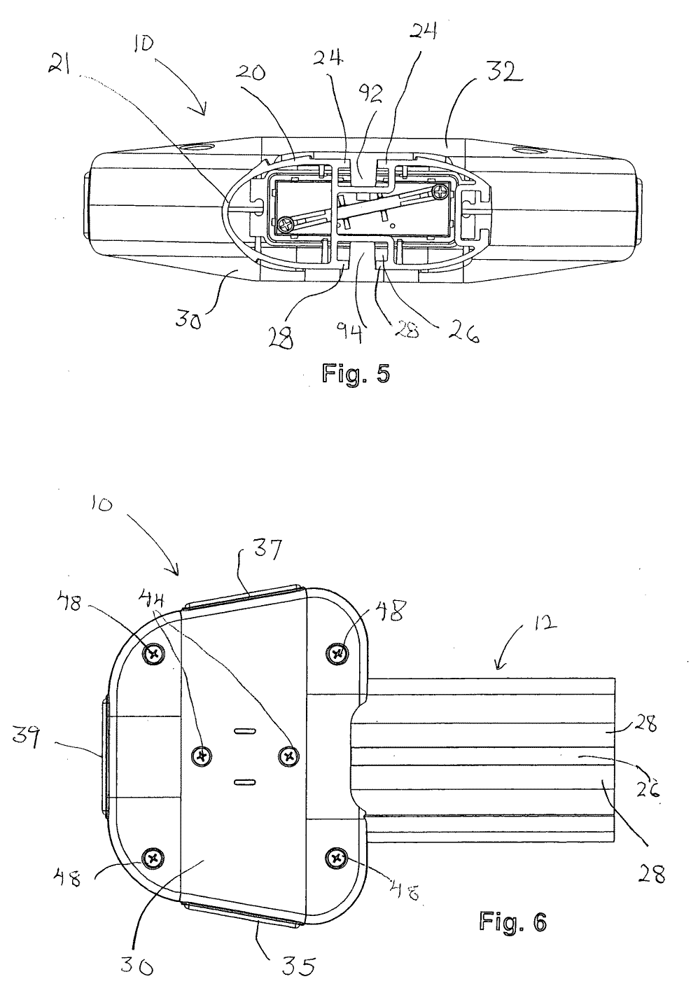

The cross-support 12 is typically an elongated extruded metal tubular member 20 with a longitudinally extending channel 22 which, at an upper portion, has a pair of opposed flanges 24 that cooperatively form a track. Various anchoring and retaining hardware 14 may be retained in the track at selected longitudinal spacings along the track for securing the cargo to be transported. With reference to FIGS. 5 and 6, the tubular member 20 may also be longitudinally traversed by a track along a channel 26 and flanges 28 along its bottom surface to provide a track at the bottom of the member for securing same to the vehicle via brackets or a support frame of the rack assembly. The front surface 21 of the rack member 20 is typically tapered to present an aerodynamic surface for the cross-support of the rack.

The warning light 10 is adapted to efficiently mount or clamp to the end of the rack member 20 to provide a warning light which is visible from both the front and rear and the side of the vehicle. The warning light 10 has a low profile, sleek and compact construction which, upon mounting to the rack and placed in use, is aerodynamically stable. The warning light 10 is structured so that it does not significantly interfere with the function of the rack, including the tracks, and is efficiently and aesthetically integrated with the rack assembly.

The warning light 10 comprises a base (bottom) shell 30 and a cover (upper) shell 32 which mount and house LED light units 34, 36 and 38. The shells 30 and 32 are preferably molded components. The shells 30 and 32 cooperate to form a smooth sculpted, aerodynamic appearance and to provide the required mounting structures for attachment to the end of the rack cross-support. In this regard, the warning light 10 is clamped onto the end of the rack cross-support 12 via an intermediate locating thread, and is secured in place from the bottom.

The side LED light units 34 and 36 are preferably angled at 10° relative to the central axis through the cross member 20 and the warning light. The end LED unit 38 is oriented to extend transversely to the axis. The LEDs preferably emit an amber light. In one preferred embodiment, the LED light units 34, 36 and 38 are LIN 3 LED warning lights which are manufactured and distributed by Whelen Engineering Company of Chester, Conn. The LED light units are sealed components which include exterior lenses 35, 37 and 39 and have a rigid housing. The light units preferably include built-in flashers and are synchronizeable and are structured as substantially described in U.S. Pat. No. 6,641,284, the disclosure of which is incorporated herein by reference.

With reference to FIGS. 3 and 6-8, the bottom shell 30 comprises a bottom panel 40 integrally connecting a pair of centrally located bosses 42 which project upwardly. The bosses 42 threadably receive fasteners 44 which connect through openings in the underside track of the rack member 20 for securing the warning light in position. The bottom shell 30 may be described as a beveled quasi-trapezoid box-like shape with four bosses 46 projecting from the panel 40 upwardly into the interior. The bosses receive fasteners 48 and threadably engage with the upper shell 32 for securing same to the lower shell.

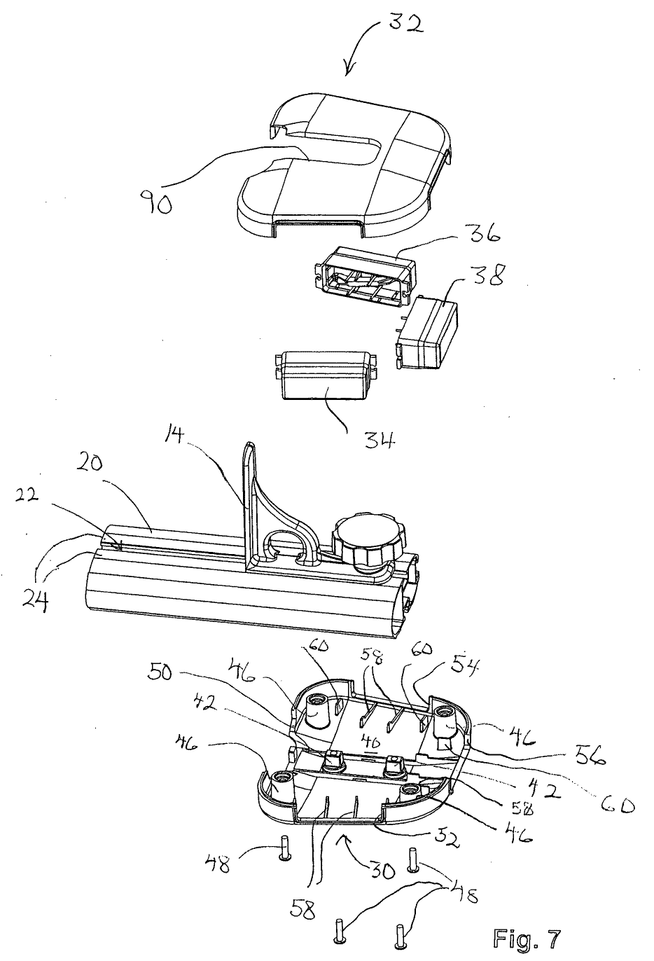

A circumferential side skirt extends upwardly along four sides from the bottom panel and forms a mounting recess opening 50 and three windows 52, 54 and 56 for receiving portions of the light units (FIG. 7). Support brackets 58 integrally project from the panel for locating, positioning and supporting the light units. Tabs 60 at opposed inward locations from the windows and spaced outwardly from the brackets 58 provide a side retaining bracket for each of the light units.

With additional reference to FIG. 11, the upper shell 32 forms a recess opening 35 which cooperates with recess opening 50 to provide a socket opening complementary to the profile of the cross-section of the tubular member 20. The upper shell also includes integral downwardly projecting bosses 47 which mate with bosses 46 for threadably receiving fasteners 48 to secure the upper shell in position to the lower shell. Upper windows 74, 76 and 78 also mate with the respective windows of the bottom panel to provide an aperture for each of the light units. In addition, locating and end retaining brackets 80 and 82 extend downwardly from the cover at its interior to engage against the top of the light units 34, 36 and 38 for properly locating and fixably capturing the light units. The upper shell 32 forms a recess 90 which longitudinally extends to provide an access to end locations of the upper track.

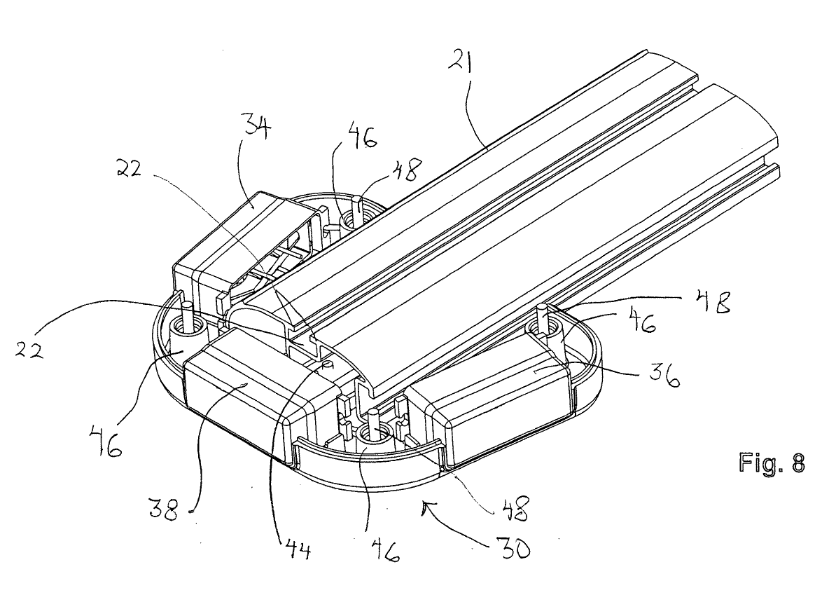

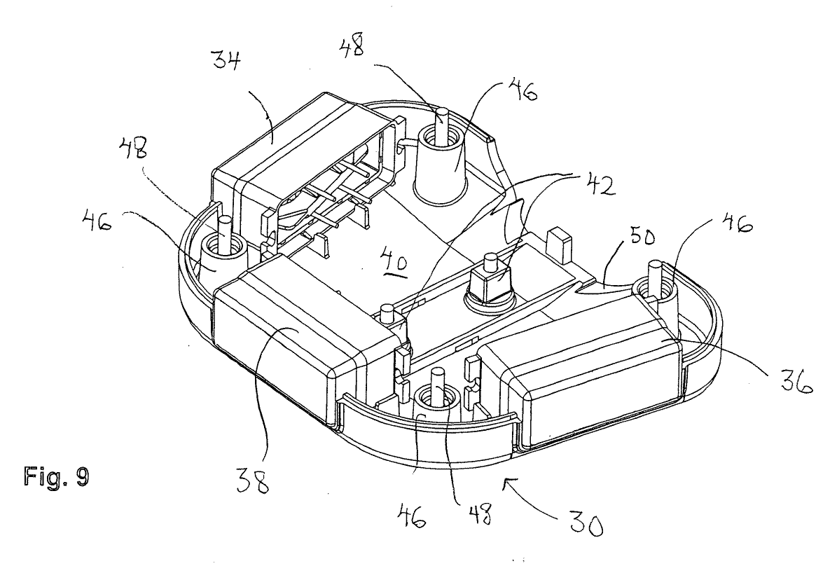

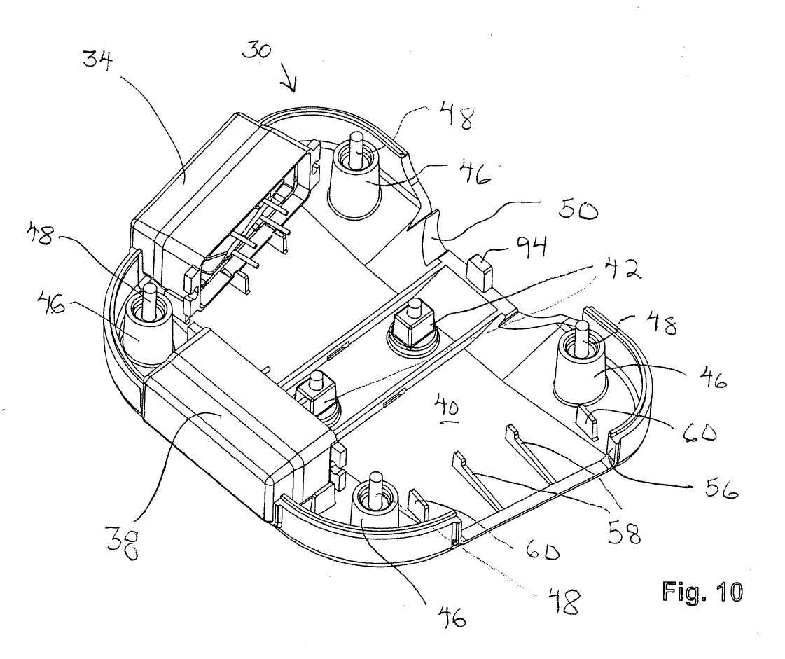

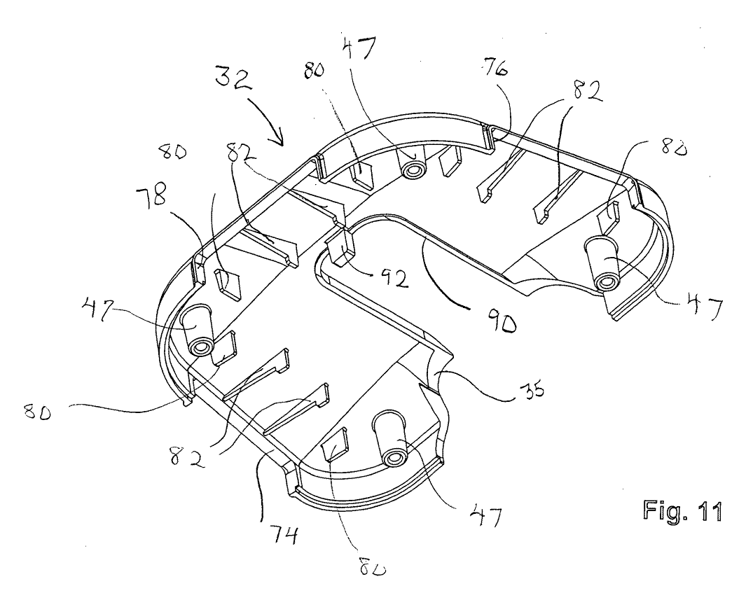

With reference to FIGS. 8-10, it should be appreciated that the spacing and structure of the retaining components including the brackets 58, 60, 80 and 82, are selected to complement the exterior housings of the light assembly so that the light units 34, 36 and 38 may be dropped into position and self-positioned with the bottom shell. The upper shell 32 functions as a top cover and is then mounted over the shell 30. Fasteners 48 are driven through the bottom base shell 30 into the shell 32 to secure the cover shell 32 in position.

It should be appreciated that the recess 90 provides access to the track of the rack cross-support 12. A stop 92 projects downwardly from the housing and engages into the upper track. Likewise, a stop 94 projects upwardly from the lower shell and is received in the lower track of the cross-support. Although the warning light 10 upon mounting may substantially seal with the support member 20, such a sealing engagement is not required because of the sealed nature of the light units 34, 36 and 38.

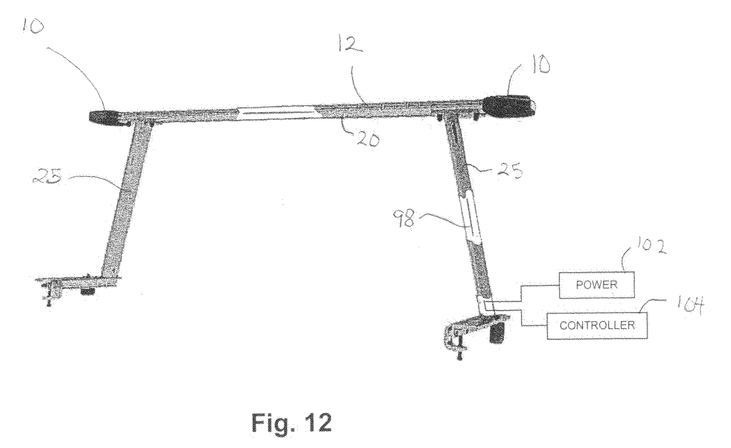

With reference to FIG. 12, the wires from each of the three light units (not illustrated) are connected as appropriate and the wire harness 98 extends through the hollow tubular rack 20 member through the rack supports 25 for connection with a power supply 102 and a controller 104 located within the vehicle cab for activating and deactivating the light units. The warning light emissions can be synchronized and function as flashers so that upon activation, warning lights will be projected from the front, rear and sides of the end of the rack. Warning lights 10 as described may be mounted to opposed ends of a rack cross-support 20 or both cross-supports (not illustrated).

While preferred embodiments of the foregoing have been set forth for purposes of illustration, the foregoing description should not be deemed a limitation of the invention herein. Accordingly, various modifications, adaptations and alternatives may occur to one skilled in the art without departing from the spirit and the scope of the present invention.

What is claimed:

1. A light module for mounting to an end of an elongated rack member comprising:
a housing having a first and an opposite second end and a pair of sides, said first end having an opening configured to receive an end of a tubular rack member and a top defining a recess;
a first light unit mounted to said housing and positioned to emit light from said second end;
a second light unit mounted to said housing and positioned to emit light from a side; and
a third light unit mounted to said housing and positioned to emit light from a second side.

2. The light module of claim 1 wherein said housing comprises a pair of shell members which cooperate to define said rack member opening and windows for said first, second and third light units.

3. The light module of claim 1 wherein said housing comprises integral mounting brackets configured to capture said light units.

4. The light module of claim 1 wherein said first, second and third light units employ LEDS and have substantially identical shapes.

5. The light module of claim 1 wherein said housing defines a central axis through said first and second ends and said sides extend at an acute angle to said axis.

6. The light module of claim 5 wherein said angle is 10°.

7. The light module of claim 5 wherein said sides converge toward said second end.

8. In combination:
a tubular rack member having opposed longitudinally spaced ends and defining a longitudinal track in an upper portion thereof; and
a light module mounted to said member at one end thereof and comprising:
a housing receiving a portion of said rack member and having a recess in a top portion to provide access to a portion of said track;
a pair of transversely spaced light units mounted to said housing and positioned to emit light in generally opposing angled directions;
a third light unit mounted to said housing and positioned to emit light in a generally longitudinally outward direction relative to said member.
